(19) United States
(12) Patent Application Publication
(10) Pub. No.: US 2015/0349588 A1
(43) Pub. Date: Dec. 3, 2015

(54) Rotating Electrical Machine

(71) Applicant: HITACHI, LTD., Chiyoda-ku, Tokyo (JP)

(72) Inventors: Hirooki TOKOI, Chiyoda-ku, Tokyo (JP); Yuji ENOMOTO, Chiyoda-ku, Tokyo (JP); Kenta DEGUCHI, Chiyoda-ku, Tokyo (JP); Taizo MIYAZAKI, Chiyoda-ku, Tokyo (JP); Koji OBATA, Chiyoda-ku, Tokyo (JP)

(21) Appl. No.: 14/654,713

(22) PCT Filed: Jan. 24, 2014
(86) PCT No.: PCT/JP2014/051432

§ 371 Date: Jun. 22, 2015

(30) Foreign Application Priority Data
Feb. 8, 2013 (JP) 2013-022803

(51) Int. Cl. H02K 1/12; H02K 5/04; H02K 3/34

(52) U.S. Cl. CPC H02K 1/12; H02K 3/34; H02K 5/04; H02K 2201/03

(57) ABSTRACT

Provided is a bearing electrolytic corrosion countermeasure technology achieving excellent reliability without increasing the number of components. A rotating electrical machine of the invention includes: a stator; a shaft penetrating the stator; a rotor facing the stator via a gap in an axial direction; and a housing holding the stator, in which: the stator includes, in a circumferential direction, a plurality of stator units each of which includes a grounded first conductive member, a core, a bobbin, and a winding wound around the bobbin; the bobbin has a flange portion provided between the winding and the rotor; the first conductive member is provided between the flange portion and the rotor and is in contact with the core, and, in a case where projection is performed in the axial direction, the winding is provided such that a projected portion of a part of the winding wound around the bobbin is within a projected portion of the flange portion; and the first conductive member is provided such that the projected portion of the first conductive member is included in the projected portion of the flange portion.

### TECHNICAL FIELD

The present invention relates to a rotating electrical machine and particularly relates to an axial-type rotating electrical machine.

### BACKGROUND ART

In recent years, variable speed operation of a rotating electrical machine using an inverter power supply has been widely performed in view of energy saving. One of problems remarkably caused when an inverter is driven is electrolytic corrosion of a bearing. As a countermeasure against this, there is a method of preventing electrolytic corrosion of a bearing by blocking, with a conductive material, electrostatic coupling of an inverter common mode voltage from a winding to a rotor to reduce a common mode voltage (hereinafter, axis voltage) induced in the rotor, thereby reducing a voltage applied between an inner ring and an outer ring of the bearing supporting the rotor.

In recent years, an axial-type rotating electrical machine has attracted attention. This rotating electrical machine has a structure in which a disk-shaped rotor and a stator are provided to face each other and is advantageous in thinning and flattening of the rotating electrical machine. This rotating electrical machine can be also structured as a double-rotor-type rotating electrical machine in which a stator is interposed between two rotors in an axial direction. In a general double-rotor-type rotating electrical machine, a plurality of independent cores each of which is wound by a winding are provided in a circumferential direction, and the general double-rotor-type rotating electrical machine includes a stator molded with resin and a rotor in which a yoke is connected to a plurality of permanent magnets provided in the circumferential direction. A torque of a motor is in proportion to a gap area that is a facing surface of the rotor and the stator. However, the double-rotor-type rotating electrical machine can increase the gap area per dimension and is therefore effective for increasing output and improving efficiency in the rotating electrical machine. The rotating electrical machine has a structure to which new magnetic materials having a low-loss property, such as amorphous, FINEMET, and nanocrystal, is effectively applicable. Those new magnetic materials are all rigid and fragile, and therefore processing thereof is difficult. In the double-rotor-type rotating electrical machine, by forming a stator core having an open slot, the core can be structured to have an extremely simple shape that is substantially a rectangular parallelepiped. Therefore, the magnetic materials can be processed to have a core shape with a simple process.

Meanwhile, in a case of the double-rotor structure described above, a facing area between the winding and the rotor is large because the double-rotor structure is the open slot structure, and the core is not grounded in many cases because the double-rotor structure is covered with resin. In this case, electrostatic coupling between the winding and the rotor becomes stronger, and therefore the common mode voltage is easily induced in the bearing.

### CITATION LIST

### Patent Literatures

PTL 1: JP-A-2004-297876
PTL 2: JP-A-2012-5307

PTLs 1 and 2 disclose a structure for blocking a space between a stator winding and a rotor. By blocking the space between the winding and the rotor, it is possible to reduce an axis voltage to suppress electrolytic corrosion of a bearing. In PTL 1, an insulating sleeve obtained by covering, with an insulator, a whole surface of a nonmagnetic conductive plate processed to have a rectangular shape is inserted into an opening of a slot, and a core grounded on the nonmagnetic conductive plate is caused to be conductive. In PTL 2, an insulator is provided on a surface of a winding, and a conductor and an insulator are alternately provided thereon in a direction orthogonal to a flow of a magnetic flux. PTL 2 also discloses a method of using a bobbin wound by the winding as the insulator.

### SUMMARY OF INVENTION

### Technical Problems

PTL 1 needs to add the insulating sleeve to a preexisting structure in order to block the space between the winding and the rotor, and thus, when comparing the number of components before and after the countermeasure, the number of components is increased. Meanwhile, a method of directly providing the conductor on a surface of the bobbin in PTL 2 does not increase the number of components. However, because the conductor is exposed to the surface, there is a fear that dielectric breakdown occurs between the conductor and the winding, which results in damage of the rotating electrical machine unless an insulation distance is securely provided. In a case where either disclosed technology is applied to a double-rotor-type axial-type rotating electrical machine, a ground structure of the conductor is problematic.

Thus, the invention provides a bearing electrolytic corrosion countermeasure technology achieving excellent reliability without increasing the number of components and provides a technology also applicable to a double-rotor-type axial-type rotating electrical machine whose core is insulated.

### Solution to Problems

In order to solve the problems, a rotating electrical machine of the invention includes: a stator; a shaft penetrating the stator; a rotor facing the stator via a gap in an axial direction; and a housing holding the stator, in which: the stator includes, in a circumferential direction, a plurality of stator units each of which includes a grounded first conductive member, a core, a bobbin, and a winding wound around the bobbin; the bobbin has a flange portion provided between the winding and the rotor; the first conductive member is provided between the flange portion and the rotor and is in contact with the core, and, in a case where projection is performed in the axial direction, the winding is provided such that a projected portion of a part of the winding wound around the bobbin is within a projected portion of the flange portion; and the first conductive member is provided such that the projected portion of the first conductive member is included in the projected portion of the flange portion.

### Advantageous Effects of Invention

In a rotating electrical machine of the invention, electrostatic coupling between a winding and a rotor is blocked by a grounded conductor, and therefore it is possible to reduce an axis voltage to suppress electrolytic corrosion of a bearing. Further, a distance between the conductor and the winding can be secured, and therefore it is possible to secure reliability in terms of dielectric breakdown.

### BRIEF DESCRIPTION OF DRAWINGS

FIG. 1 is a perspective view of an axial-type rotating electrical machine according to this embodiment.

FIG. 2 is a cross-sectional view taken along an arrow A of FIG. 1.

FIG. 3 is a perspective view of a stator unit 115 forming a stator 100.

FIG. 4 is an enlarged view of a part surrounded by an alternate long and short dash line C of FIG. 1.

FIG. 5 is a cross-sectional view of an axial-type rotating electrical machine, illustrating another embodiment of a first conductive member.

FIG. 6 is a perspective view of a stator unit 115 forming a stator 100.

FIG. 7 is an enlarged view of a part surrounded by an alternate long and short dash line C of FIG. 5.

FIG. 8 is a cross-sectional view of an axial-type rotating electrical machine, illustrating another embodiment of a first conductive member.

FIG. 9 is a cross-sectional view of an axial-type rotating electrical machine, illustrating another embodiment of a core.

FIG. 10 is a cross-sectional view illustrating an axial-type rotating electrical machine 1 according to another embodiment to which a second conductive member is added.

FIG. 11 is a perspective view of a stator unit 115 forming a stator 100 and a periphery thereof.

FIG. 12 is a perspective view of a stator unit, illustrating another example of a first conductive member which is applicable to this embodiment illustrated above.

FIG. 13 is a perspective view of a stator unit, illustrating another example of a first conductive member which is applicable to this embodiment illustrated above.

### DESCRIPTION OF EMBODIMENTS

Hereinafter, an example of the invention will be described with reference to drawings.

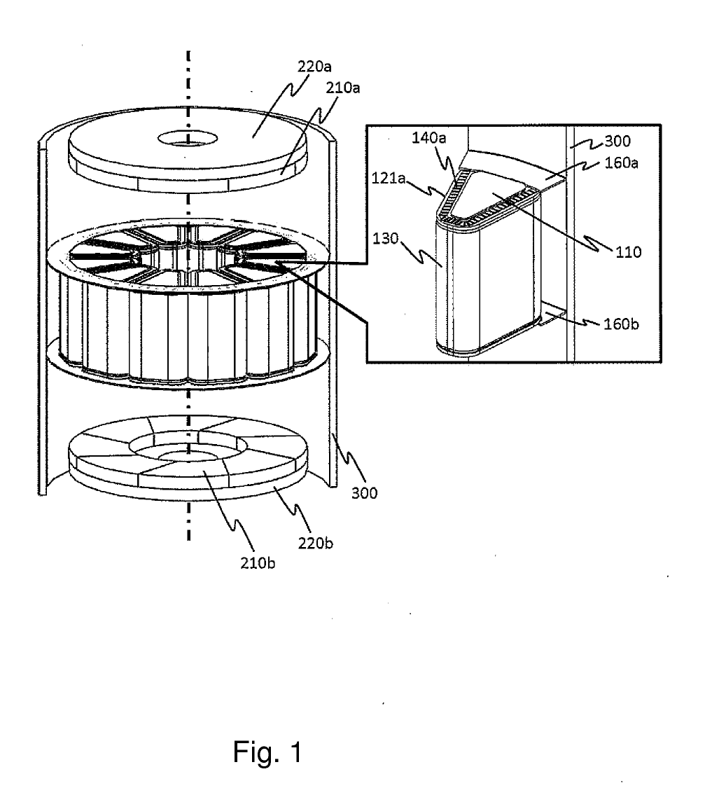

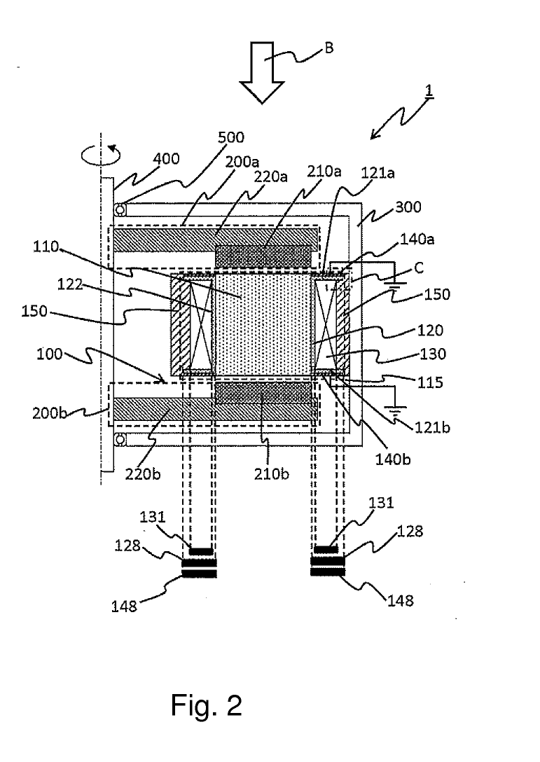

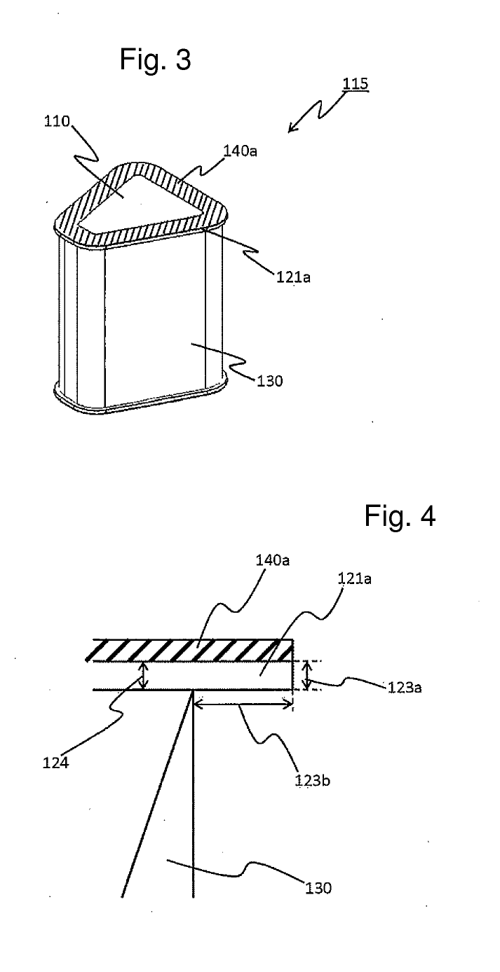

FIG. 1 is a perspective view of an axial-type rotating electrical machine according to this embodiment. FIG. 2 is a cross-sectional view taken along an arrow A of FIG. 1. FIG. 3 is a perspective view of a stator unit 115 forming a stator 100. FIG. 4 is an enlarged view of a part surrounded by an alternate long and short dash line C of FIG. 1.

A rotating electrical machine 1 includes the stator 100 and two rotors 200a and 200b between which the stator 100 is interposed in an axial direction. In the stator 100, the plurality of stator units 115, each of which includes a core made of a soft magnetic material, a bobbin 120 surrounding a core 110, and a winding 130 wound around the bobbin 120, are provided in a circumferential direction. Further, the stator 100 is integrally molded with a housing 300 made of resin 150. That is, the housing 300 holds the stator 100.

The rotor 200a includes a yoke 220a made of soft magnetic material and a plurality of permanent magnets 210a provided in the circumferential direction and connected to the yoke 220a. The rotor 200b includes a yoke 220b made of soft magnetic material and the plurality of permanent magnets 210a provided in the circumferential direction and connected to the yoke 220b. The rotor 200a and the rotor 200b are connected via a bearing 500 to a shaft 400 rotatably fixed to the housing 300.

The bobbin 120 has a tubular portion 122 forming a housing space for housing the core 110, a flange portion 121a connected to one end surface in the axial direction of the tubular portion 122 and protruded between the rotor 200a and the winding 130, and a flange portion 121b connected to the other end surface in the axial direction of the tubular portion 122 and protruded between the rotor 200b and the winding 130.

A first conductive member 140a is provided on a surface of the flange portion 121a, the surface facing the rotor 200a, and is in contact with the core 110. A first conductive member 140b is provided on a surface of the flange portion 121b, the surface facing the rotor 200b, and is in contact with the core 110. The first conductive member 140a and the first conductive member 140b are grounded.

As illustrated in FIG. 2, in a case where projection is performed from an arrow B in parallel with the axial direction, the winding 130 is provided such that a projected portion 131 of a part of the winding wound around the bobbin 120 is within a projected portion 128 of the flange portion 121a or the flange portion 121b. The first conductive member 140a or the first conductive member 140b is provided such that a projected portion 148 of the first conductive member 140a or the first conductive member 140b is included in the projected portion 128 of the flange portion 121a or the flange portion 121b. With this structure, as illustrated in FIG. 4, a shortest one-line distance 124 between the first conductive member 140a and the winding 130 is smaller than a shortest creepage distance (sum of a distance 123a and a distance 123b) between the first conductive member 140a and the winding 130.

Operation of the axial-type rotating electrical machine of this embodiment will be described. Herein, a motor operation example will be described. An alternating current is caused to flow through the winding 130 with the use of an inverter and an AC power supply (not illustrated). With this, an alternating magnetic field is generated on a surface of the stator 100. This alternating magnetic field and a static magnetic field of the rotor 200a and the rotor 200b caused by the permanent magnet 210a and permanent magnet 210b are attracted and repelled, and thus the rotor 200a and the rotor 200b are rotated to generate a torque.

An effect of the axial-type rotating electrical machine of this embodiment will be described. The space between the winding 130 and the rotor 200a or the rotor 200b is blocked by the grounded first conductive member 140a. This suppresses generation of a potential difference between the winding 130 and the rotor 200a or the rotor 200b. Therefore, a potential difference between inner and outer rings of the bearing 500 is also reduced. As a result, it is possible to suppress generation of an axis current caused by breakage of an oil film in the bearing 500 and suppress generation of electrolytic corrosion in the bearing 500 caused by the generation of the axis current.

The first conductive member 140a provided on the surface of the flange portion 121a and the winding 130 are provided to have a thickness of the flange portion 121a (distance 123a illustrated in FIG. 4) and a creepage distance (distance 123b illustrated in FIG. 4) which is a distance between a tip of the flange portion 121a and the winding 130. This makes it possible to secure an electrical insulation property between the first conductive member 140a and the winding 130 to suppress dielectric breakdown between the first conductive member 140a and the winding 130.

Note that, although an example of providing the two rotors 200a and 200b at both ends of the stator 100 has been described in this embodiment, another axial-type rotating electrical machine in which a single rotor facing a single stator including a back yoke is provided may be also employed. Further, still another axial-type rotating electrical machine in which a single rotor is interposed between two stators 100 including a back yoke may be also employed.

Note that the first conductive member 140a and the first conductive member 140b are desirably made of a nonmagnetic material. This makes it possible to suppress flux leakage to the first conductive member 140a and the first conductive member 140b to improve output and efficiency of the rotating electrical machine. The first conductive member 140a and the first conductive member 140b are provided on the bobbin 120 by a post-process such as plating, deposition, or adhesion. Alternatively, the first conductive member 140a and the first conductive member 140b may be integrally formed with the bobbin 120. The first conductive member 140a and the first conductive member 140b may be embedded in the flange portions, instead of being provided on the surfaces of the flange portion 121a and the flange portion 121b of the bobbin 120.

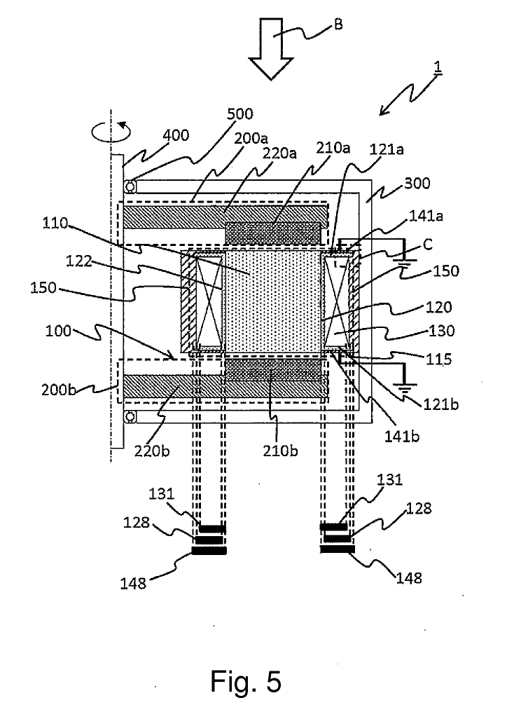

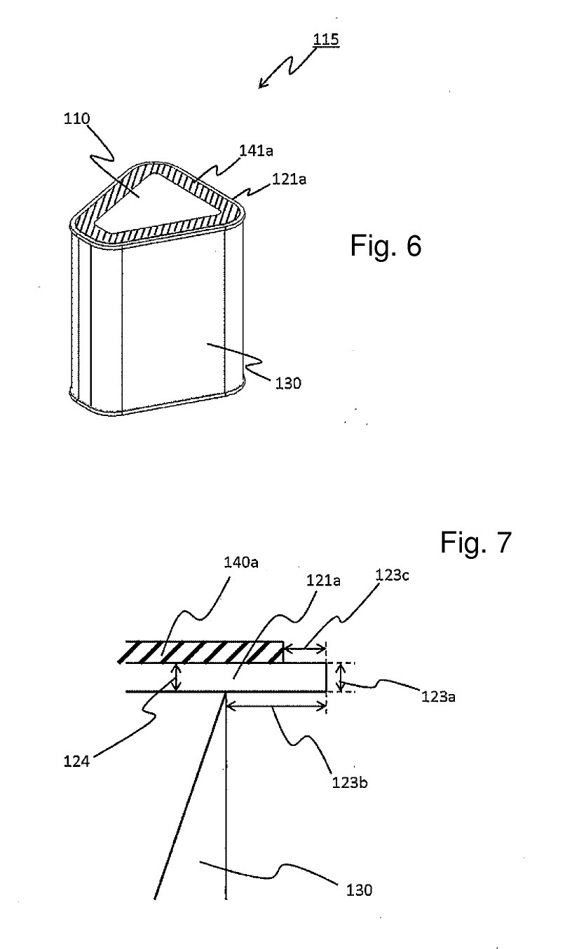

FIG. 5 is a cross-sectional view of the axial-type rotating electrical machine, illustrating another embodiment of the first conductive member. Description of a structure, operation, and an effect that are the same as those of FIG. 1 to FIG. 4 are omitted. FIG. 6 is a perspective view of the stator unit 115 forming the stator 100. FIG. 7 is an enlarged view of a part surrounded by an alternate long and short dash line C of FIG. 5.

In this embodiment, a first conductive member 141a is provided such that a projected portion 132 of the first conductive member 141a is within the projected portion 148 of the flange portion 121a. A first conductive member 141b is provided such that the projected portion 132 of the first conductive member 141b is within the projected portion 148 of the flange portion 121b.

That is, as illustrated in FIG. 7, a tip of the flange portion 121a and the first conductive member 141a have a distance 123c. This makes it possible to wind the winding 130 to the vicinity of the tip of the flange portion 121a and the flange portion 121b to effectively use a stator space.

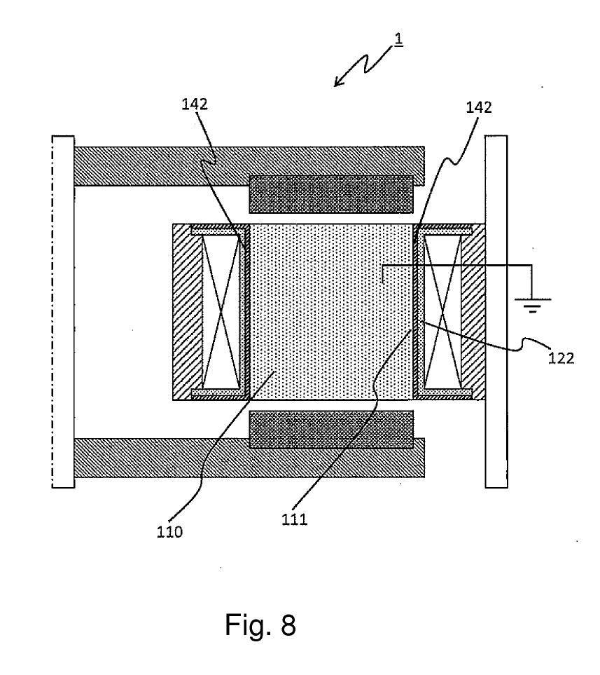

FIG. 8 is a cross-sectional view of the axial-type rotating electrical machine, illustrating another embodiment of the first conductive member.

Description of a structure, operation, and an effect that are the same as those of FIG. 1 to FIG. 4 are omitted.

A first conductive member 142 is also formed in a space between the tubular portion 122 and the core 110. The first conductive member 142 is in contact with a core surface 111 of the core 110, the core surface 111 facing the tubular portion 122. With this, the first conductive member 142 is firmly fixed between the tubular portion 122 and the core 110. This makes it possible to improve connection reliability with the core 110.

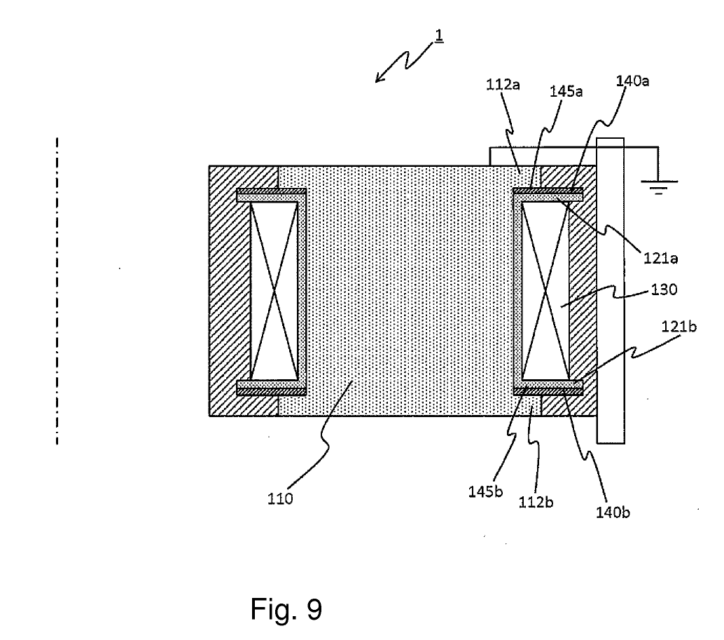

FIG. 9 is a cross-sectional view of the axial-type rotating electrical machine, illustrating another embodiment of the core. Description of a structure, operation, and an effect that are the same as those of FIG. 1 to FIG. 4 are omitted.

The core 110 has a core-side flange portion 112a provided between the first conductive member 140a and a rotor (not illustrated) provided in the axial direction. The core-side flange portion 112a is in contact with a surface 145a of the first conductive member 140a, the surface 145a being an opposite surface of a surface that is in contact with the flange portion 121a. The core 110 also has a core-side flange portion 112b provided between the first conductive member 140b and a rotor (not illustrated) provided in the axial direction. The core-side flange portion 112b is in contact with a surface 145b of the first conductive member 140b, the surface 145b being an opposite surface of a surface that is in contact with the flange portion 121b. Note that, although the core 110 is grounded in this embodiment, the first conductive member 140a may be grounded. With this, the first conductive member 140a or the first conductive member 140b is firmly fixed between the flange portion 121a or the flange portion 121b and the core-side flange portion 112a or the core-side flange portion 112b the core 110. This makes it possible to improve the connection reliability with the core 110.

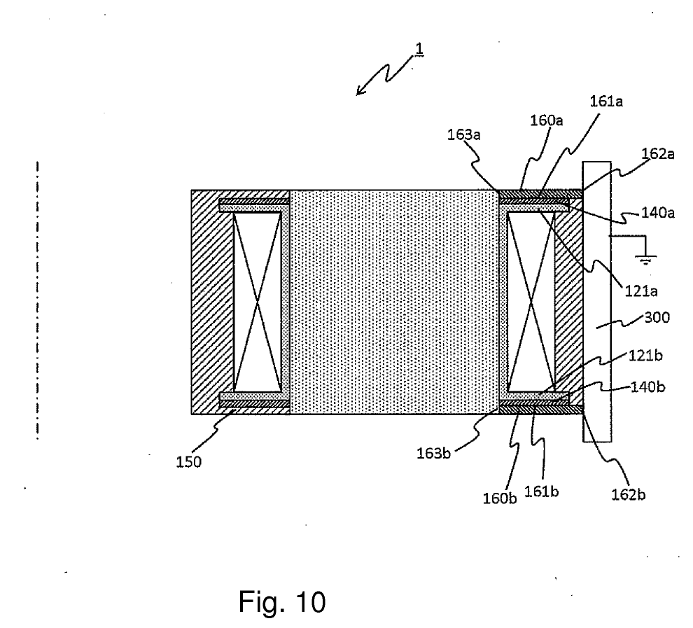

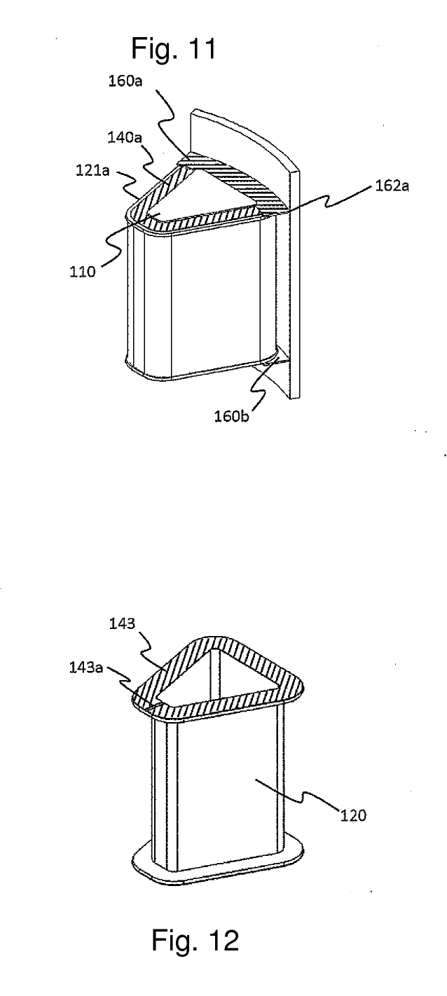

FIG. 10 is a cross-sectional view illustrating the axial-type rotating electrical machine 1 according to another embodiment to which a second conductive member is added. FIG. 11 is a perspective view of the stator unit 115 forming the stator 100 and a periphery thereof.

A second conductive member 160a is provided between the first conductive member 140a and a rotor (not illustrated) provided in the axial direction. A second conductive member 160b is provided between the first conductive member 140b and a rotor (not illustrated) provided in the axial direction. The second conductive member 160a has a first contact surface 161a that is in contact with a surface 146a of the first conductive member 140a, the surface 146a being an opposite surface of a surface that is in contact with the flange portion 121a and a second contact surface 162a that is in contact with an inner wall of the housing 300. The housing 300 is grounded. The second conductive member 160b has a similar structure.

Thus, the first conductive member 140a and the second conductive member 160a are in surface contact with each other, which results in easy conduction. A heat dissipation path of internal components of the axial-type rotating electrical machine is mainly provided in a direction from the inner wall to an outer wall of the housing 300. In view of this, by using the second conductive member 160a of this embodiment, heat generated in the stator can be transmitted to the inner wall of the housing 300 via the second conductive member 160a. This makes it possible to improve a heat dissipation property of the axial-type rotating electrical machine.

Because the core 110 is molded with the resin 150, it is necessary to additionally provide means for grounding the plurality of cores 110 that are provided in the circumferential direction and are electrically independent. In view of this, the second conductive member 160a has a third contact surface 163a that is in contact with the core 110. A third contact surface 163b has a similar structure. This makes it possible to simultaneously secure grounding of the first conductive member 140a and the core 110, reduce the number of components, and simplify the structure. This can improve electrical connection reliability for grounding.

Note that, although the second conductive member 160a is assumed to have a 360° continuous ring shape in FIG. 10 and FIG. 11, a shape of the second conductive member 160a is arbitrary. The second conductive member 160a may be divided into a plurality of parts in the circumferential direction. The individual second conductive members 160a may be separated. The second conductive member 160a is desirably formed by a nonmagnetic conductor made of aluminum or the like. This makes it possible to reduce flux leakage to the second conductive member 160a to improve output and efficiency of the rotating electrical machine. Note that, in a case where the second conductive member 160a and the core 110 are caused to be conductive by different means, the second conductive member 160a may be provided on arbitrary one of end surfaces in the axial direction. In a case where the second conductive member 160a is formed by a high thermal conductor such as aluminum, a heat dissipation property of the stator can be also improved. In this case, by providing the second conductive members 160a at the both end surfaces of the stator, a heat dissipation effect can be doubled.

FIG. 12 is a perspective view of a stator unit, illustrating another example of the first conductive member which is applicable to this embodiment illustrated above.

The stator unit has a cut portion 143a so that a first conductive member 143 provided around a tip of a core is discontinuous in the circumferential direction. With this, a necessary minimum shield area is reduced, and thus a loop of an eddy current flowing through the first conductive member 143 around the core can be cut off and generation of a loss can be suppressed. This makes it possible to improve output and efficiency of the rotating electrical machine.

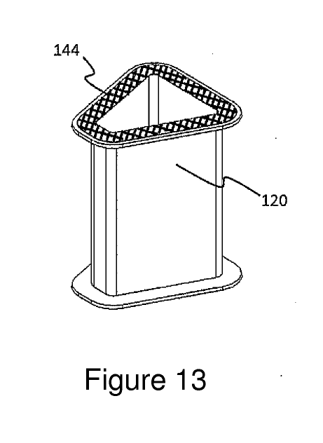

Note that, although a single cut portion is provided in the circumferential direction in this embodiment, a plurality of slits may be provided so as not to largely reduce the shielding area and separate the first conductive member. Further, as illustrated in FIG. 13, a first conductive member 144 may be meshed. An arrangement pattern of the first conductive member 144 can be formed by a pattern at the time of printing or deposition. Alternatively, the first conductive member 144 can be discontinuously grounded by providing protrusions and recesses corresponding to a pattern on a conductor placement surface of the bobbin in advance.

### REFERENCE SIGNS LIST

1 . . . rotating electrical machine, 100 . . . stator, 110 . . . core, 111 . . . core surface, 112a . . . core-side flange portion, 115 . . . stator unit, 120 . . . bobbin, 121a . . . flange portion, 121b . . . flange portion, 122 . . . tubular portion, 123a . . . distance, 123b . . . distance, 123c . . . distance, 124 . . . one-line distance, 128 . . . projected portion, 130 . . . winding, 131 . . . projected portion, 132 . . . projected portion, 140a . . . first conductive member, 140b . . . first conductive member, 141a . . . first conductive member, 141b . . . first conductive member, 142 . . . first conductive member, 143 . . . first conductive member, 144 . . . first conductive member, 143a . . . cut portion, 145a . . . surface, 145b . . . surface, 146a . . . surface, 146b . . . surface, 148 . . . projected portion, 150 . . . resin, 160a . . . second conductive member, 160b . . . second conductive member, 161a . . . first contact surface, 162a . . . second contact surface, 163a . . . third contact surface, 163b . . . third contact surface, 200a . . . rotor, 200b . . . rotor, 210a . . . permanent magnet, 210b . . . permanent magnet, 220a . . . yoke, 220b . . . yoke, 300 . . . housing, 400 . . . shaft, 500 . . . bearing

1. A rotating electrical machine, comprising:
a stator;
a shaft penetrating the stator;
a rotor facing the stator via a gap in an axial direction; and
a housing holding the stator, wherein:
the stator includes, in a circumferential direction, a plurality of stator units each of which includes a grounded first conductive member, a core, a bobbin, and a winding wound around the bobbin;
the bobbin has a flange portion provided between the winding and the rotor;
the first conductive member is provided between the flange portion and the rotor and is in contact with the core, and, in a case where projection is performed in the axial direction, the winding is provided such that a projected portion of a part of the winding wound around the bobbin is within a projected portion of the flange portion; and
the first conductive member is provided such that the projected portion of the first conductive member is included in the projected portion of the flange portion.

2. The rotating electrical machine according to claim 1, wherein
the first conductive member is provided such that the projected portion of the first conductive member is within the projected portion of the flange portion.

3. The axial-type rotating electrical machine according to claim 1, wherein:
the bobbin has a tubular portion forming a space for housing the core;
the first conductive member is also formed in a space between the tubular portion and the core; and
the first conductive member is in contact with a surface of the core, the surface facing the tubular portion.

4. The axial-type rotating electrical machine according to claim 1, wherein:
the core has a core-side flange portion provided between the first conductive member and the rotor; and
the core-side flange portion is in contact with a surface of the first conductive member, the surface being an opposite surface of a surface that is in contact with the flange portion.

5. The axial-type rotating electrical machine according to claim 1, comprising
a second conductive member provided between the first conductive member and the rotor, wherein:
the housing is grounded; and
the second conductive member has a first contact surface that is in contact with a surface of the first conductive member, the surface being an opposite surface of a surface that is in contact with the flange portion and a second contact surface that is in contact with an inner wall of the housing.

6. The axial-type rotating electrical machine according to claim 5, wherein
the second conductive member has a third contact surface that is in contact with the core.
